(19) United States
(12) Patent Application Publication
(10) Pub. No.: US 2015/0293847 A1
(43) Pub. Date: Oct. 15, 2015

(54) METHOD AND APPARATUS FOR LOWERING BANDWIDTH AND POWER IN A CACHE USING READ WITH INVALIDATE

(71) Applicant: QUALCOMM Incorporated, San Diego, CA (US)

(72) Inventors: George PATSILARAS, Del Mar, CA (US); Moinul H. KHAN, San Diego, CA (US); Pankaj CHAURASIA, San Diego, CA (US); Bohuslav RYCHLIK, San Diego, CA (US); Feng WANG, San Diego, CA (US); Anwar Q. ROHILLAH, San Diego, CA (US); Subbarao PALACHARLA, San Diego, CA (US)

(73) Assignee: QUALCOMM Incorporated, San Diego, CA (US)

(21) Appl. No.: 14/251,628

(22) Filed: Apr. 13, 2014

(51) Int. Cl. G06F 12/08; G06F 12/12

(52) U.S. Cl. CPC G06F 12/0833; G06F 12/0808; G06F 12/128; G06F 2212/62; G06F 2212/69

(57) ABSTRACT

Ephemeral data stored in a cache is read when needed but is not written to system memory so as to save power and bandwidth. In an embodiment, a no-writeback bit associated with the ephemeral data is set in response to a read-no-writeback instruction. Data in a cache line for which its no-writeback bit has been set is not written back into system memory. Accordingly, when evicting cache lines, if a cache line has a no-writeback bit set, then the data in that cache line is discarded without being written back to system memory.

### FIELD OF DISCLOSURE

Embodiments relate to cache memory in an electronic system.

### BACKGROUND

For many of kinds of consumer electronic devices, such as for example cell phones and tablets, there are some types of data present in cache that need not be stored in system memory. Such data may be termed ephemeral data. For example, someone viewing an image rendered in the display of a mobile phone or tablet may wish to rotate the image. Internally generated data related to an image rotation in many circumstances need not be stored in system memory. However, many devices may write such ephemeral data into system memory when performing a cache line replacement policy. Write operations of ephemeral data unnecessarily consume power and memory bandwidth.

### SUMMARY

Embodiments of the invention are directed to systems and methods for lowering bandwidth and power in a cache using a read with invalidate.

In an embodiment, a method comprises receiving at a cache a read-no-writeback instruction indicating an address; and setting a no-writeback bit in the cache to indicate a cache line associated with the address as not to be written to a memory upon eviction of the cache line from the cache.

In another embodiment, a cache comprises storage to store data associated with cache lines, each cache line having a corresponding no-writeback bit; and a controller coupled to the storage, the controller, in response to receiving a read-no-writeback instruction indicating a cache line, setting a no-writeback bit corresponding to the cache line to indicate the cache line as not to be written to a memory upon eviction of the cache line from the cache.

In another embodiment, a system comprises a memory; a device; and a cache coupled to the device, the cache, upon receiving a read-no-writeback instruction from the device indicating an address of a cache line stored in the cache, the cache line having a corresponding no-writeback bit, to set the no-writeback bit to indicate the cache line is not to be written to the memory upon eviction of the cache line from the cache.

### BRIEF DESCRIPTION OF THE DRAWINGS

The accompanying drawings are presented to aid in the description of embodiments of the invention and are provided solely for illustration of the embodiments and not limitation thereof.

FIG. 1 illustrates a system in which an embodiment finds application.

FIG. 2 illustrates a method according to an embodiment.

FIG. 3 illustrates another method according to an embodiment.

FIG. 4 illustrates another method according to an embodiment.

FIG. 5 illustrates another method according to an embodiment.

FIG. 6 illustrates a communication network in which an embodiment may find application.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that specific circuits (e.g., application specific integrated circuits (ASICs)), one or more processors executing program instructions, or a combination of both, may perform the various actions described herein. Additionally, the sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

In performing a read operation on ephemeral data stored in a cache, some embodiments include the capability of tagging the ephemeral data as no-writeback data so that the tagged ephemeral data will not be written into system memory. The no-writeback tag is in addition to a conventional valid tag to indicate whether the corresponding data is valid or not. The no-writeback tagging may be accomplished in several ways, for example whereby the cache inspects the bus signaling associated with a read operation performed by a bus master. For example, the bus signaling may include a specialized version of a read instruction, where the opcode of the read instruction indicates that upon reading a cache line of data, the data is to be tagged as no-writeback. Another method is for the cache to inspect the MasterID (master identification) associated with the reading device (e.g., a display), and to tag the data as no-writeback depending upon the MasterID. Another method is to modify the transaction attribute in a transaction between a reading device and the cache to include a flag, where the flag may be set by the reading device to cause the cache upon performing the read operation to tag the cache line as no-writeback data.

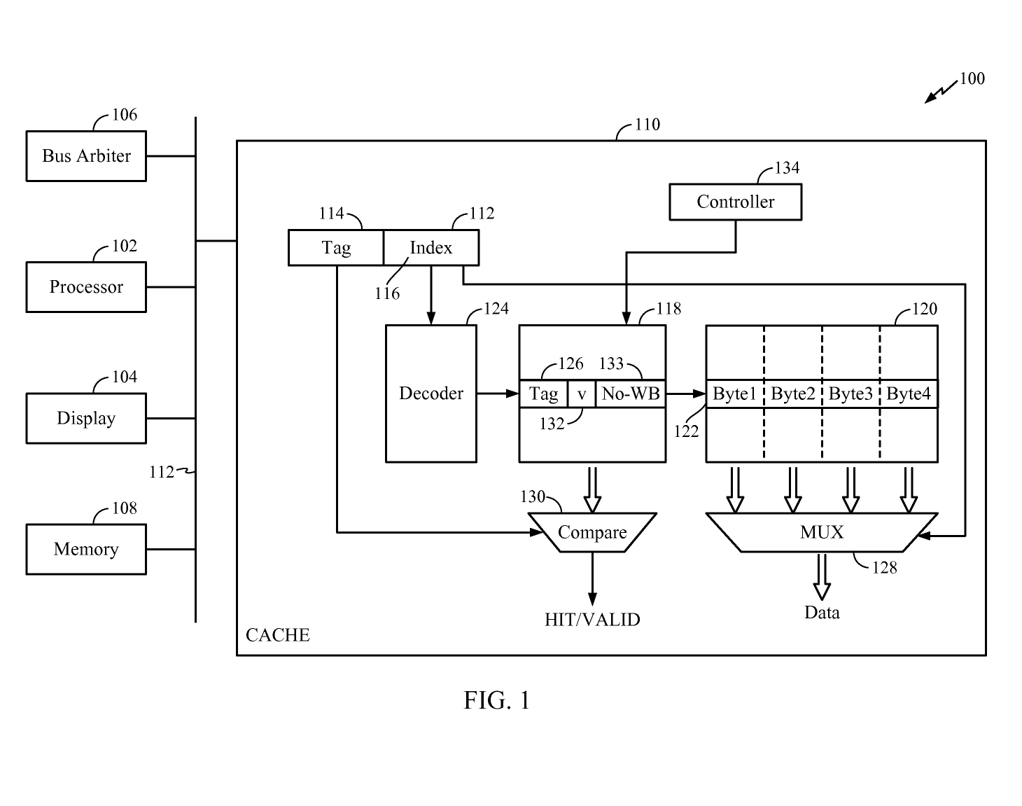

FIG. 1 illustrates a system 100 in which an embodiment may find application. The system 100 comprises the processor 102 that may be used to process and manipulate images displayed on the display 104. Also included in the system 100 are the bus arbiter 106, the system memory 108, the cache 110, and the system bus 112. The system 100 may represent, for example, part of a larger system, such as a cellular phone or tablet.

For simplicity of illustration, not all components of a system are illustrated in FIG. 1. Some of the components illustrated in the system 100 may be integrated on one or more semiconductor chips. For example, the cache 110 may be integrated with the processor 102, but for simplicity it is shown as a separate component coupled to the system bus 112. As another example, the processor 102 may perform the function of the bus arbiter 106. Furthermore, the system memory 108 may be part of a memory hierarchy, and there may be several levels of cache. For simplicity, only one level, the cache 110, is shown.

The processor 102 may be dedicated to the display 104 and optimized for image processing. However, embodiments are not so limited, and the processor 102 may represent a general application processor for a cellular phone or tablet, for example. For some embodiments, all or most of the components illustrated in FIG. 1 may be dedicated to the display 104, or optimized for image processing. For example, the cache 110 may be integrated with the processor 102 and dedicated to the display 104, where the system memory 108 is shared with other components not shown.

The cache 110 includes a register 112 for holding a cache address. In the particular example of FIG. 1, a cache address stored in the register 112 includes two fields, a tag field 114 and an index field 116, where the value in the tag field 114 is an upper set of bits of the cache address and the value in the index field 116 is a lower set of bits of the cache address. For the particular example of FIG. 1, the cache 110 is organized as a direct-mapped cache with the tags stored in the RAM (Random Access Memory) 118 and corresponding cache lines of data stored in the RAM 120. For other embodiments, a cache may be organized in other ways, such as for example as a set-associative cache. It is immaterial to the discussion whether the RAM 118 and the RAM 120 are implemented as separate RAMs or one RAM. Other types of storage to store the cache lines and associated bits may be used. For the particular example of FIG. 1, each cache line, such as the cache line 122, comprises four bytes of data.

An upper set of bits in the index field 116 is provided to the decoder 124, which is used to index into the RAM 118 to obtain the tag 126 associated with the cache line 122. A lower set of bits in the index field 116 is used with the multiplexer 128 to select a particular byte stored in the cache line 122. The tag 126 is compared with the value stored in the tag field 114 by the comparator 130 to indicate if there is a match. In addition to the tag 126, the upper set of bits stored in the index field 116 is used to index into the RAM 118 to provide a valid bit 132 associated with the cache line 122, where the valid bit 132 indicates whether the data stored in the cache line 122 is valid. If the tag 126 matches the value of the tag field 114, and if the valid bit 132 indicates that the cache line 122 is valid, then there is a valid hit indicating that the data stored in the cache line 122 has the correct address and is valid.

In addition to providing the valid bit 132, the upper set of bits stored in the index field 116 indexes into the RAM 118 to provide a no-writeback bit 133 associated with the cache line 122. The no-writeback bit 133 indicates whether the data stored in the cache line 122 should be written back to the system memory 108 upon eviction of the cache line 122 from the cache 110. If the no-writeback bit 133 has been set, then regardless of the cache policy in place, the cache line 122 is not written back to the system memory 108.

For some embodiments, the instruction set for the processor 102 includes a read-no-writeback instruction. A read-no-writeback instruction is an instruction for which one of its parameters is an address, and when it is received by the cache 110, the data associated with that address is read from the appropriate cache line as in a conventional read operation. Provided the appropriate cache line is found, the no-writeback bit associated with the cache line is set to indicate that the cache line is not to be written back to the system memory 108 when evicted from the cache. With the no-writeback bit set in this way, data in the cache line will not be written into system memory (or a higher level of cache). If after receiving a read-no-writeback instruction a cache coherence policy sends a write-back instruction to the cache 110, cache lines marked as no-writeback will not be written into memory (e.g., the system memory 108). Here, reference to the cache 110 receiving an instruction may mean that various bus signals are provided to the cache 110 indicative of the instruction.

For some embodiments, the no-writeback bit can be used as a means to select the next-to-be replaced cache line. In such an embodiment, the replacement policy is to search those cache lines having a set no-writeback bit, and to evict such cache lines before evicting valid cache lines for which their no-writeback bit has not been set. This is based on the premise that the ephemeral data has seen its last use and can be replaced.

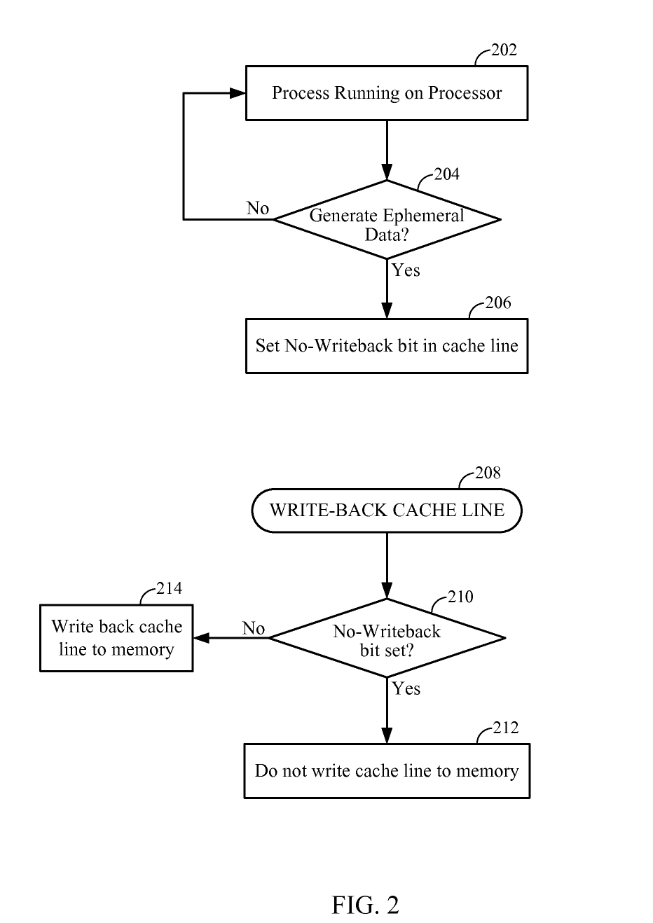

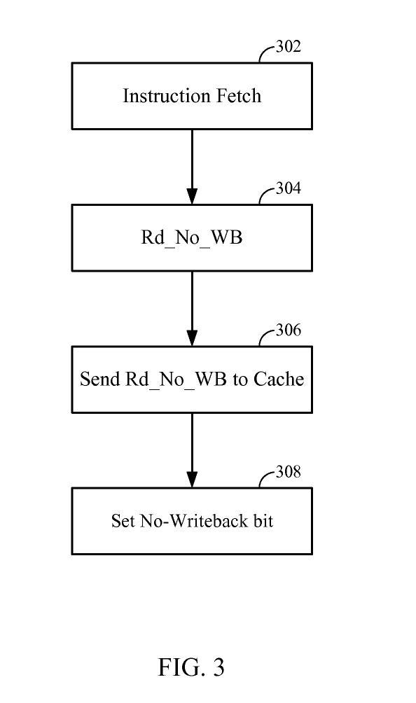

FIGS. 2 and 3 illustrate some of the above-described embodiments. For a process running on a processor (step 202), if ephemeral data is generated (step 204), then the no-writeback bit in the cache line for the cached ephemeral data is set so that the ephemeral data will not be written back to system memory. If when implementing a cache coherence policy a write-back instruction for a cache line is received by a cache (step 208), then if the no-writeback bit associated with the cache line is set (step 210), then the cache line will not be written to system memory (step 212) regardless of the particular cache line replacement policy in place. If, however, the no-writeback bit is not set (step 210), then the cache line may be written to system memory provided it is valid (step 214).

Referring to FIG. 3, upon an instruction fetch (step 302), if a read-no-writeback instruction is decoded (step 304), then a read-no-writeback instruction is sent to the cache (step 306). A cache executing the read-no-writeback instruction causes a read of the data associated with the cache line indicated by the address parameter of the read-no-writeback instruction, and sets the corresponding no-writeback bit so that the cache line will not be written back to system memory (step 308).

Some of the processes indicated in FIGS. 2 and 3 may be performed by the processor 102, and others may be performed in the cache 110, for example by the controller 134 for setting a no-writeback bit in the RAM 118.

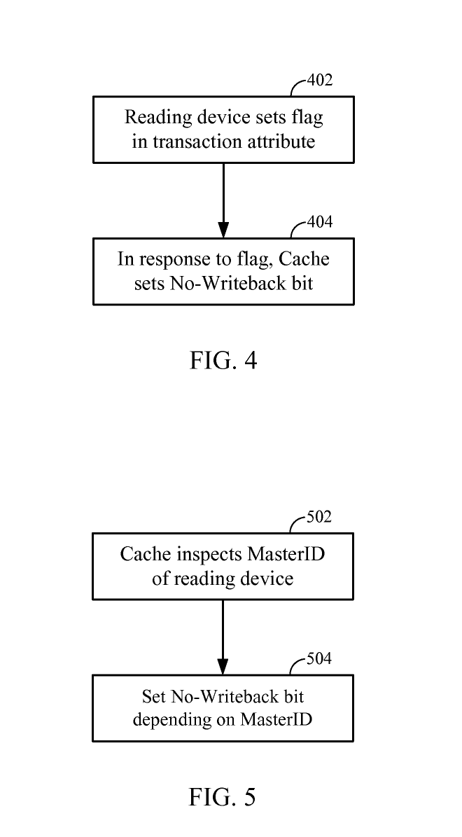

For some embodiments, a no-writeback bit associated with a cache line may be set according to a modified transaction attribute associated with a device (e.g., a display in a cellular phone) reading the cache. The transaction attribute includes a flag, where the flag may be set by the device to indicate that the no-writeback bit is to be set in the corresponding cache line stored in the cache when the read operation is performed. This is illustrated in FIG. 4, where in step 402 a device that is to read data in a cache line sets a flag in a transaction attribute, and in step 404 the cache controller 134 sets the no-writeback bit in the cache line to indicate that it is ephemeral data.

FIG. 5 illustrates another method. In step 502 the cache 110 inspects a MasterID associated with a reading device, such as for example a display, and depending upon the particular MasterID, the cache controller 134 sets the no-writeback bit associated with the cache line to indicate that the data in the cache line is ephemeral data (step 504).

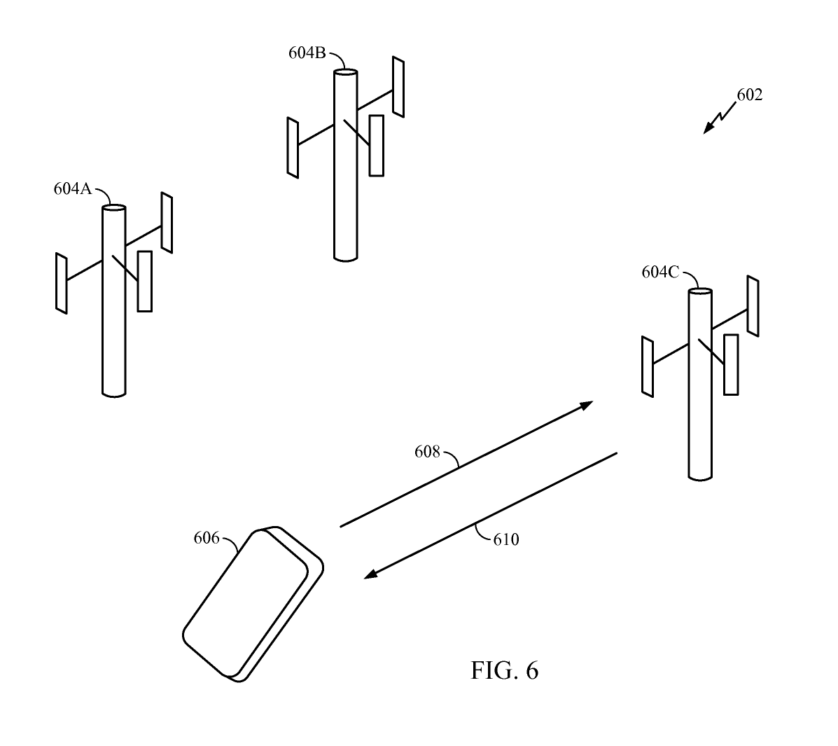

FIG. 6 illustrates a wireless communication system in which embodiments may find application. FIG. 6 illustrates a wireless communication network 602 comprising base stations 604A, 604B, and 604C. FIG. 6 shows a communication device, labeled 606, which may be a mobile communication device such as a cellular phone, a tablet, or some other kind of communication device suitable for a cellular phone network, such as a computer or computer system. The communication device 606 need not be mobile. In the particular example of FIG. 6, the communication device 606 is located within the cell associated with the base station 604C. Arrows 608 and 610 pictorially represent the uplink channel and the downlink channel, respectively, by which the communication device 606 communicates with the base station 604C.

Embodiments may be used in data processing systems associated with the communication device 606, or with the base station 604C, or both, for example. FIG. 6 illustrates only one application among many in which the embodiments described herein may be employed.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a non-transitory computer readable media embodying a method for lowering bandwidth and power in a cache using read with invalidate. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method comprising:
receiving at a cache a read-no-writeback instruction indicating an address; and
setting a no-writeback bit in the cache to indicate a cache line associated with the address as not to be written to a memory upon eviction of the cache line from the cache.

2. The method of claim 1, further comprising:
evicting the cache line in response to a replacement policy before evicting other cache lines having no-writeback bits not set.

3. The method of claim 1, further comprising:
setting by a device a flag in a transaction attribute, the device to read the cache line in a cache; and
setting by a cache controller in response to the flag the no-writeback bit associated with the cache line so that the cache line is not written to the memory.

4. The method of claim 3, further comprising:
evicting the cache line in response to a replacement policy before evicting other cache lines having no-writeback bits not set.

5. The method of claim 3, further comprising:
inspecting at the cache a received master identification corresponding to the device; and
setting the no-writeback bit associated with the cache line depending upon the master identification so that the cache line is not written to the memory.

6. The method of claim 1, further comprising:
inspecting at the cache a received master identification corresponding to a device, the device to read data in a cache line stored in the cache; and
setting the no-writeback bit associated with the cache line depending upon the master identification so that the cache line is not written to the memory.

7. A cache comprising:
storage to store data associated with cache lines, each cache line having a corresponding no-writeback bit; and
a controller coupled to the storage, the controller, in response to receiving a read-no-writeback instruction indicating a cache line, setting a no-writeback bit corresponding to the cache line to indicate the cache line as not to be written to a memory upon eviction of the cache line from the cache.

8. The cache of claim 7, the controller further to evict the cache line in response to a replacement policy before evicting other cache lines having no-writeback bits not set.

9. The cache of claim 8, the controller further to inspect a received master identification corresponding to a device, the device to read data in the cache line, and to set the no-writeback bit associated with the cache line depending upon the master identification so that the cache line is not written to the memory.

10. The cache of claim 7, the controller further to inspect a received master identification corresponding to a device, the device to read data in the cache line, and to set the no-writeback bit associated with the cache line depending upon the master identification so that the cache line is not written to the memory.

11. The cache of claim 7, wherein the cache is part of an apparatus selected from the group consisting of cellular phone, tablet, and computer system.

12. A system comprising:
a memory;
a device; and
a cache coupled to the device, the cache, upon receiving a read-no-writeback instruction from the device indicating an address of a cache line stored in the cache, the cache line having a corresponding no-writeback bit, to set the no-writeback bit to indicate the cache line is not to be written to the memory upon eviction of the cache line from the cache.

13. The system of claim 12, the cache further to evict the cache line in response to a replacement policy before evicting other cache lines having no-writeback bits not set.

14. The system of claim 12,
the device to set a flag in a transaction attribute to read the cache line in the cache; and
the cache, in response to the flag, to set the no-writeback bit so that the cache line is not written to the memory.

15. The system of claim 14, the cache further to evict the cache line in response to a replacement policy before evicting other cache lines having no-writeback bits not set.

16. The system of claim 14,
the device having a master identification; and
the cache receiving and inspecting the received master identification, the cache to set the no-writeback bit depending upon the master identification so that the cache line is not written to the memory.

17. The system of claim 12, wherein the device is a display.
